(19) United States
(12) Patent Application Publication
(10) Pub. No.: US 2015/0017729 A1
(43) Pub. Date: Jan. 15, 2015

(54) METHOD FOR EVALUATION TESTING OF MATERIAL FOR INTERNAL COMBUSTION ENGINE

(71) Applicant: SIMITOMO ELECTRIC INDUSTRIES, LTD., Osaka-shi, Osaka (JP)

(72) Inventors: Hajime Ota, Osaka-shi (JP); Taichiro Nishikawa, Osaka-shi (JP); Masao Sakuta, Neyagawa-shi (JP); Kazuo Yamazaki, Neyagawa-shi (JP); Takeshi Tokuda, Neyagawa-shi (JP); Shin Tomita, Neyagawa-shi (JP); Yoshiyuki Takaki, Osaka-shi (JP)

(21) Appl. No.: 14/375,543

(22) PCT Filed: Dec. 27, 2012
(86) PCT No.: PCT/JP2012/083773

§ 371 Date: Jul. 30, 2014

(30) Foreign Application Priority Data
Feb. 2, 2012 (JP) 2012-021226
Jun. 27, 2012 (JP) 2012-144430

(51) Int. Cl. G01M 15/04; G01N 17/00

(52) U.S. Cl. CPC G01M 15/042; G01N 17/006
USPC 436/6

(57) ABSTRACT

An oxide film is formed on the surface of a sample made from a metal material by holding the above-described sample at a temperature of 800° C. or higher and 1,100° C. or lower in an oxygen-containing atmosphere, and the sample provided with the oxide film is immersed in a corrosive solution containing an acid and NaCl for a predetermined time. After immersion, the corrosion state (degree of denseness of oxide film, cracking state, and the like) of the sample is evaluated. The corrosion resistance of the sample can be evaluated appropriately and conveniently in a short period of time by causing accelerated corrosion in an environment simulating the actual environment of an internal combustion engine.

### TECHNICAL FIELD

The present invention relates to a method for evaluation testing of a material for an internal combustion engine, the method being utilized for evaluating the characteristics of constituent members, which are incorporated in an internal combustion engine, and materials therefor, for example, an electrode of a spark plug incorporated in an automobile engine and an electrode material. In particular, the present invention relates to a method for evaluation testing of a material for an internal combustion engine, the method being capable of evaluating the corrosion resistance conveniently.

### BACKGROUND ART

Parts of internal combustion engines, such as, spark plugs incorporated in internal combustion engines, e.g., gasoline engines of automobiles, have been previously used in a gasoline combustion atmosphere under a very high temperature environment in which the maximum temperature of 800° C. to 1,000° C. has been reached. Consequently, in the case where the characteristics e.g., high temperature oxidation resistance, of internal combustion engine parts, e.g., the above-described spark plug, are evaluated, an endurance test by using a test engine capable of actually combusting gasoline (hereafter referred to as engine test) has been utilized (the paragraph [0055] of specification of PTL 1).

As for an evaluation method for examining the characteristics, e.g., the high temperature oxidation resistance, more conveniently without using a special apparatus, e.g., the above-described test engine, the above-described high-temperature environment has been noted and a simple oxidation test in the air atmosphere or a thermal cycle test, in which high temperature heating and cooling are repeated, has been utilized.

In recent years, for the sake of environmental preservation measures and the like, an improvement in fuel efficiency has been attempted by further raising the combustion temperature in an automobile engine and the like or performing exhaust gas recirculation (EGR). Also, for the sake of environmental preservation measures, idling stop of automobile engines and the like has become executed.

### CITATION LIST

### Patent Literature

PTL 1: Japanese Patent No. 4413951

### SUMMARY OF INVENTION

### Technical Problem

The use environment of the constituent members of the internal combustion engine, e.g., electrodes of spark plugs, has become easier to cause oxidation·corrosion because of a further increase in the temperature during use of an internal combustion engine, an increase in the number of ON/OFF times of engine due to idling stop, and the like. Therefore, it is desirable that the oxidation resistance and the corrosion resistance of the constituent members of the internal combustion engine, e.g., electrodes of spark plugs, and the raw materials for the constituent members of the internal combustion engine, e.g., electrode materials, be improved. In order to improve the corrosion resistance, it is necessary that the corrosion resistance be examined to grasp the corrosion resistance of the constituent members and the raw materials therefor.

However, an appropriate technique to accurately and conveniently examine the corrosion resistance of the constituent members of the internal combustion engine and the raw materials therefor, e.g., electrodes for spark plugs and electrode materials, has not been studied previously.

According to the examination by the present inventors, as described later, the corrosion states were very different between a sample actually used in an automobile and a sample subjected to the above-described simple oxidation test and the like. Consequently, it is desirable to develop a technique in which the same corrosion environment as that in the actual use environment can be established conveniently and the corrosion resistance can be evaluated accurately and easily.

Accordingly, it is an object of the present invention to provide an evaluation testing method capable of evaluating the corrosion resistance of a material for an internal combustion engine conveniently.

### Solution to Problem

The present inventors examined the corrosion state of a sample actually used for an automobile, and performed various studies on the reproduction test of this corrosion state. As a result, it was found that a state very close to the corrosion state of the sample actually used for the automobile was brought about by forming an oxide film on the sample and, thereafter, performing immersion in a corrosive solution for a certain time. The reason why such results were obtained is considered as described below.

The constituent member of the internal combustion engine, e.g., an electrode of spark plug, is brought to a high temperature of 800° C. or higher, and furthermore about 900° C. to 1,100° C., as described above, so that an oxide film (typically, a layer made from an oxide of a main element of the above-described constituent member) is formed on the surface thereof. Then, it is considered that grains constituting the surface of the above-described constituent member are coarsened because of a very high temperature, and an inside region (region close to the constituent member) in the oxide film comes into a state in which grain boundaries of oxide are sparse as compared with the region on the surface side (outside region). On the other hand, it was found that when idling stop was performed as described above, the temperature of the above-described constituent member was lowered to cause dew condensation and the above-described constituent member came into the state of being immersed in dew condensation water. Also, it was found that elements from surroundings of the above-described constituent member (typically, NOx components resulting from EGR) were mixed into this dew condensation water and, thereby, a specific corrosive solution, specifically a corrosive solution containing an acid, was generated in some cases. Therefore, when the number of times of ON/OFF increases because of idling stop, dew condensation water is generated repeatedly and, furthermore, EGR and the like are performed, so that the above-described corrosive solution is generated repeatedly. Meanwhile, if the duration of stop of engine increases because of the idling stop, the above-described constituent member is immersed in a generated corrosive solution successively. Consequently, it is considered that, in the constituent member provided with the above-described oxide film, the corrosive solution permeated into the inside more deeply and easily along the grain boundaries of coarse grains constituting at least the inside region of the oxide film, and corrosion proceeded from the inside region.

Accordingly, it can be said that a testing method including the steps from formation of the oxide film to immerse in the corrosive solution can be utilized as a test to evaluate the corrosion state of the constituent members of the internal combustion engine and the raw materials therefor, e.g., electrodes for spark plugs and electrode materials, accurately and conveniently. The present invention is based on the above-described findings.

The present invention relates to a method for evaluation testing of a material for an internal combustion engine to evaluate the characteristics of a metal material of an electrode incorporated in the internal combustion engine, a raw material therefor, or the like, and the method includes a preliminary oxidation step and a corrosive solution immersion step, as described below.

Preliminary oxidation step: a step to form an oxide film on the surface of a sample made from the above-described metal material by holding the sample at a temperature of 800° C. or higher and 1,100° C. or lower in an oxygen-containing atmosphere.

Corrosive solution immersion step: a step to prepare an aqueous solution containing an acid and sodium chloride as a corrosive solution and immerse the sample provided with the above-described oxide film in the corrosive solution for a predetermined time.

The method for evaluation testing of a material for an internal combustion engine, according to the present invention, can reproduce the corrosion state, which may be influenced by the denseness and adhesion of the oxide film, presence or absence of crack, and the like, accurately by forming the oxide film on the material for the internal combustion engine and, thereafter, performing immersion in the corrosive solution, as described above. More specifically, the corrosion state in the actual use environment (typically, use for an automobile) can be reproduced accurately. Consequently, the method for evaluation testing of a material for an internal combustion engine, according to the present invention, can be used favorably as a simulation test of the actual environment or a preliminary test of an engine test (narrowing down of the types in the case where, for example, a plurality of alloys are prototyped, simple evaluation, pre-shipment test, and the like). Meanwhile, the method for evaluation testing of a material for an internal combustion engine, according to the present invention, can accelerate corrosion by using a solution containing sodium chloride as the corrosive solution, so that the test time can be decreased significantly. Therefore, the method for evaluation testing of a material for an internal combustion engine, according to the present invention, can perform an evaluation of the characteristics, in particular an evaluation of the corrosion resistance, of the constituent member of the internal combustion engine and the raw material therefor, e.g., an electrode for a spark plug and an electrode material used for this electrode, accurately in a short period of time. Also, the method for evaluation testing of a material for an internal combustion engine, according to the present invention, can be used as a screening method because the constituent member and the raw material therefor having excellent corrosion resistance can be selected on the basis of the evaluation results.

As one aspect according to the present invention, an aspect is mentioned, in which the above-described oxide film is formed by holding for 1 hour or more and 100 hours or less in the air atmosphere, or holding for 2 hours or more and 200 hours or less in a low-oxidizing atmosphere in which the oxygen concentration is lower than that in the air.

In the aspect in which the oxide film is formed in the air atmosphere, the atmosphere can be controlled easily and, in addition, the oxygen concentration is relatively high. Therefore, the oxide film can be formed in a short period of time and the test time can be decreased. On the other hand, the oxygen concentration in the atmosphere of the internal combustion engine, e.g., a gasoline engine, is usually lower than that in the air. Therefore, in the aspect in which the oxide film is formed in a low-oxidizing atmosphere, the environment having a low oxygen concentration can be simulated accurately.

As one aspect according to the present invention, an aspect is mentioned, in which the above-described acid is at least one type of hydrochloric acid, phosphoric acid, nitric acid, and sulfuric acid.

The acids listed above are acids which may be generated in the actual use environment, e.g., an internal combustion engine of a gasoline engine. Therefore, it can be said that the above-described aspect, in which a corrosive solution containing the acids listed above is used, simulates a corrosive solution which may be generated in the actual environment and, thereby, the corrosion resistance can be evaluated accurately.

As one aspect according to the present invention, an aspect is mentioned, in which steps to form the above-described oxide film by holding at a temperature of 900° C. for 24 hours in the air atmosphere and examine the state of the above-described resulting oxide film are further included.

The state of the oxide film formed under the above-described specific condition was examined. As a result, it was found that the state of this oxide film was close to the state of the oxide film formed on the constituent member of the internal combustion engine used for the actual automobile rather than the state of the oxide film after being subjected to the simple oxidation test (for example, 1,000° C.×72 hours to 100 hours). Also, it was found that there was a relationship between the oxide film formed under this specific condition and the corrosion resistance, and when this oxide film was in a specific state, the corrosion resistance tended to become excellent. Consequently, the above-described aspect in which the oxide film is formed and, thereafter, the state of the oxide film is examined before immersion in the corrosive solution can evaluate the performance of the corrosion resistance to some extent on the basis of the state of the oxide film, and the performance of the corrosion resistance can be evaluated more accurately on the basis of the state after immersion in the corrosive solution.

### Advantageous Effects of Invention

The method for evaluation testing of a material for an internal combustion engine, according to the present invention, can evaluate the corrosion resistance of the material for an internal combustion engine conveniently.

### BRIEF DESCRIPTION OF DRAWINGS

FIG. 1A is a photomicrograph (SEM photograph) showing the state of corrosion and shows Sample No. 1 subjected to the method for evaluation testing of a material for an internal combustion engine, according to the present invention.

FIG. 1B is a photomicrograph (SEM photograph) showing the state of corrosion and shows Sample No. 100 actually used for an automobile.

FIG. 1C is a photomicrograph (SEM photograph) showing the state of corrosion and shows Sample No. 200 subjected to a simple oxidation test.

FIG. 2 shows composition mapping on the basis of SEM-EPMA analysis of Sample No. 100 actually used for an automobile.

FIG. 3 shows composition mapping on the basis of SEM-EPMA analysis of Sample No. 200 subjected to a simple oxidation test.

### REFERENCE SIGNS LIST

10 base material
11 inside oxide layer
12 outside oxide layer

### DESCRIPTION OF EMBODIMENTS

The present invention will be described below in more detail. To begin with, test object will be described.

### Test Object

Examples of test objects include those made from metal materials, such as, constituent members (for example, electrodes) incorporated in parts (for example, spark plugs) constituting an internal combustion engine and raw materials (for example, electrode materials) used for the constituent members.

The composition of the metal material, which is the test object, is not specifically limited. The method for evaluation testing of a material for an internal combustion engine, according to the present invention, can be utilized favorably for evaluation of characteristics of a nickel alloy utilized for an electrode material serving as an electrode of a spark plug or a raw material therefor. Specific examples of nickel alloys include alloys containing at least one type of addition element of Al, Si, Cr, Y, Ti, Mn, Fe, Nb, Ta, Mo, Cu, and the like and the remainder composed of Ni and inevitable impurities. Examples of inevitable impurities include C and S. Some extent of C may be contained.

The form of the test object is not specifically limited. Examples of raw materials used for the above-described constituent member include wire rods (typically, round wires and rectangular wires) and plate materials. A cut piece produced by cutting the above-described wire rod or plate material into an appropriate length may be employed as a sample. The above-described constituent member is a formed article produced by forming the above-described raw material into a predetermined shape, and the resulting formed article can be used as a sample on an as-is basis.

### Evaluation Testing Method

### <Preparation of Sample>

Initially, a sample made from an appropriate metal material is prepared, as described above.

### <Preliminary Oxidation>

Subsequently, the surface of the prepared sample is heated at a high temperature to coarsen and oxidize crystal grains constituting the region on the surface side of the sample, so that an oxide film provided with a layer made from a coarse oxide is formed. As for the oxidation at a high temperature, the heating temperature is specified to be 800° C. or higher and 1,100° C. or lower in order to simulate the high-temperature environment in the internal combustion engine, e.g., an automobile gasoline engine. As the heating temperature increases, the oxide film tends to become thick, and excessive oxide film may hinder permeation of the corrosive solution. Therefore, the heating temperature is more preferably 900° C. or higher and 1,000° C. or lower. The heating temperature can be adjusted in accordance with the environment to be simulated. the holding time, oxygen concentration, and the like described later.

In the preliminary oxidation step, an oxygen-containing atmosphere is employed because an oxide film is formed. Specific examples of the atmospheres include the air atmosphere. As for the air atmosphere, the atmosphere can be controlled easily and the oxygen concentration is relatively high. Therefore, the oxide film can be formed in a short period of time and the test time can be decreased, so that the operability is excellent.

Alternatively, a low-oxidizing atmosphere having an oxygen concentration lower than that in the air can be employed. Specific examples of oxygen concentrations include 0.01 percent by volume or more and 20 percent by volume or less. In the atmosphere of a combustion gas in the internal combustion engine, e.g., an automobile gasoline engine, the oxygen concentration (20 percent by volume or less) is usually lower than that in the air. Therefore, it can be said that this form simulates a state closer to the actual environment. Examples of atmospheric gases other than oxygen include inert gases, e.g., nitrogen, argon, and helium. A mixed gas by mixing the oxygen gas and the above-described inert gas, a mixed gas by mixing the oxygen gas and the air, and the like can be utilized for formation of the low-oxidizing atmosphere.

As for the holding time of the above-described heating temperature, a time sufficient for forming the oxide film may be selected and, for example, 1 hour or more is mentioned. In the case where the oxygen concentration of the atmosphere is constant, the oxide film tends to become thick as the heating temperature is increased or the holding time is increased. If the oxide film is too thick, permeation of the corrosive solution may become insufficient, as described above, so that in the case where the air atmosphere is employed, the holding time is preferably 1 hour or more and 100 hours or less, further preferably 1 hour or more and 72 hours or less, and particularly preferably 2 hours or more and 24 hours or less. Formation of the oxide film tends to take more time as the oxygen concentration becomes low, so that in the case where the above-described low-oxidizing atmosphere is employed, the holding time is preferably specified to be longer than that in the air atmosphere, 2 hours or more and 200 hours or more is more preferable, 3 hours or more is further preferable, and 10 hours or more and 100 hours or less is particularly preferable. The holding time can be selected within the above-described range in accordance with the environment to be simulated, the heating temperature, the oxygen concentration, and the like.

A furnace (for example, air atmosphere furnace) having the above-described predetermined atmosphere can be utilized for formation of the oxide film.

### <Examination of State of Oxide Film>

After the oxide film is formed on the sample, immersion in the corrosive solution may be performed immediately. However, the state of the resulting oxide film may be examined. Here, in the case where an oxide film is formed on a nickel alloy containing the above-described addition element, the oxide film tends to have a double structure of an inside oxide layer and a surface oxide layer formed on the surface side of the oxide film. Therefore, in grasping the state of the oxide film, examples of contents·items of examination of the oxide film include whether the resulting oxide film has a double structure or not, the thickness of the inside oxide layer, the thickness of the surface oxide layer, the total thickness of the inside oxide layer and the surface oxide layer, and the ratio of the thickness of the inside oxide layer to the thickness of the surface oxide layer. Then, according to examination by the present inventors, it was found that in the case where the above-described thicknesses, ratio, and the like fell within specific ranges, excellent corrosion resistance was exhibited even after immersion in the corrosive solution thereafter, although there are differences depending on the material. That is, a preliminary opinion related to the performance of the corrosion resistance is obtained by examining the state of the oxide film formed in the above-described preliminary oxidation step and the performance of the corrosion resistance can be evaluated more accurately by further performing the corrosive solution immersion step to execute immersion in the corrosive solution. Therefore, addition of a step to examine the state of the formed oxide film after the preliminary oxidation step and before the corrosive solution immersion step is proposed. In this regard, preferable ranges of the above-described thicknesses and ratio can be set by the examination on a material basis.

Meanwhile, according to examination by the present inventors, it was found that in examination of the state of the oxide film, preferably, the oxide film was formed in the air atmosphere at 900° C. for 24 hours. Therefore, in the case where the step to examine the state of the oxide film is included, it is proposed that the preliminary oxidation step is performed in the air atmosphere at 900° C. for 24 hours.

### <Immersion in Corrosive Solution>

In the corrosive solution immersion step, initially, a corrosive solution, into which the sample provided with the above-described oxide film is to be immersed, is prepared. The corrosive solution primarily contains water because dew condensation water is simulated. In this regard, the corrosive solution is specified to be an aqueous solution containing chloride ions (Cl⁻) because corrosion can be accelerated and the test time can be decreased effectively by containing chloride ions (Cl⁻). In particular, a sodium chloride (NaCl) aqueous solution is used as the base aqueous solution to ensure neutrality. The concentration of NaCl (mass percentage) in the NaCl aqueous solution can be selected appropriately, although 1% or more and 10% or less is convenient. It is considered that NaCl in itself does not become a main cause of corrosion easily in this range.

In addition, the corrosive solution is specified to contain an acid. It is considered that, in the case where the above-described EGR is performed, nitric acid resulting from NOx contained in an exhaust gas may be generated. Meanwhile, according to examination by the present inventors, elements, e.g., sulfur (S) and phosphorus (P), were detected in the test piece actually used for an automobile. Sulfur is considered to be an impurity in gasoline, and phosphorus is considered to be an impurity in engine oil. Then, it is considered that sulfuric acid may be caused by S and phosphoric acid may be caused by P. Moreover, it is considered that hydrochloric acid may be caused by chlorides on the basis of parts of the internal combustion engine. In this manner, various acids may be generated in the use environment of the internal combustion engine, e.g., a gasoline engine, and therefore, it is proposed that the corrosive solution contains an acid in addition to NaCl. In particular, at least one type of the above-described nitric acid, sulfuric acid, phosphoric acid, and hydrochloric acid is preferable. In the case where a single acid is employed, preparation and adjustment of concentration are easy and in the case where a plurality of types of acids are used in combination, it is expected that the simulated corrosive solution is closer to the corrosive solution which may be generated in an actual environment.

The concentration of the acid can be selected appropriately. When the total mass of the corrosive solution is specified to be 100, the mass of NaCl aqueous solution: the mass of acid=about 50:50 to 99:1 is convenient, although depending on the type of acid. It is expected that sufficient corrosion can be executed within this range of ratio by relatively short time (about 2 hours to 48 hours) of immersion. Meanwhile, the temperature of the corrosive solution may be room temperature (about 20° C. to 25° C.), although the corrosion can be more accelerated and the immersion time can be further decreased by employing about 50° C. to 80° C.

The immersion time can be selected appropriately in accordance with the environment to be simulated, the material of the sample, the composition of the corrosive solution (acid concentration, NaCl concentration), the temperature, and the like. For example, 1 hour or more and 200 hours or less is mentioned.

In particular, as for a sample made from a nickel alloy constituting an electrode of a spark plug incorporated in an internal combustion engine, e.g., an automobile gasoline engine, and an electrode material, the immersion time of 2 hours or more and 48 hours or less is appropriate.

### <Evaluation>

After the sample is immersed in the above-described corrosive solution for a predetermined time, the sample is pulled up from the corrosive solution, followed by drying, and the corrosion state is evaluated. Examples of evaluations include an evaluation by using absolute value data obtained by performing microscope observation of a cross section (thickness of oxide film, degree of denseness of oxide film, presence or absence of crack, and the like), composition analysis (quantification of constituent elements, identification of remaining elements, and the like), measurement of surface resistance, and the like.

On the other hand, a sample serving as a reference (hereafter referred to as a reference sample) is prepared, the above-described absolute data are compared between the reference sample and the sample of the test object to determine the performance of the corrosion resistance and, thereby, a metal material having excellent characteristics can be selected. That is, the method for evaluation testing of a material for an internal combustion engine, according to the present invention, can also be utilized for selection of a material having excellent characteristics.

In the case where the state of the oxide film is examined as described above, the corrosion resistance is comprehensively evaluated by preliminary evaluation on the basis of the state of oxide film and the final evaluation on the basis of the absolute data obtained after immersion in the above-described corrosive solution. Alternatively, determination of the performance by the preliminary evaluation is more accurately determined by the final evaluation.

### Test Example 1

The validity of the method for evaluation testing of a material for an internal combustion engine, according to the present invention, will be examined with reference to test examples.

A nickel alloy electrode material, which has been used as a raw material for the electrode of a spark plug incorporated in an automobile gasoline engine, was prepared as a sample. Here, a rectangular wire rod made from a nickel alloy containing 1.5% Cr-1.5% Si-2% Mn, on a percent by mass basis, and the remainder composed of Ni and inevitable impurities was prepared. This rectangular wire rod was produced by a known manufacturing method·condition (melting·casting→hot rolling→cold rolling→softening).

Sample No. 100 was a sample which was actually used in an automobile (utility car) provided with a gasoline engine and was evaluated in an actual use state. Specifically, a commercially available spark plug was prepared, a side electrode of this spark plug was changed to an electrode formed from the above-described rectangular wire rod, and the resulting spark plug was attached to a prepared automobile. Subsequently, about 20,000 km was traveled after the plug was changed. Idling stop and the like were performed during the driving test, and a plurality times of ON/OFF of the engine was performed.

Sample No. 200 was a sample which was subjected to a simple oxidation test. Specifically, the above-described rectangular wire rod was subjected to high-temperature oxidation under the condition of 1,000° C.×72 hours in the air atmosphere.

As for Sample No. 100, the electrode of the spark plug was taken out after the above-described driving of the automobile. As for Sample No. 200, the rectangular wire rod was taken out after the simple oxidation test. Each sample (electrode or rectangular wire rod) was cut by cross-section polisher (CP) and the cross section was taken. The microstructure of this cross section was observed with a scanning electron microscope (SEM) and, in addition, element analysis was performed with a SEM-EPMA surface analyzer.

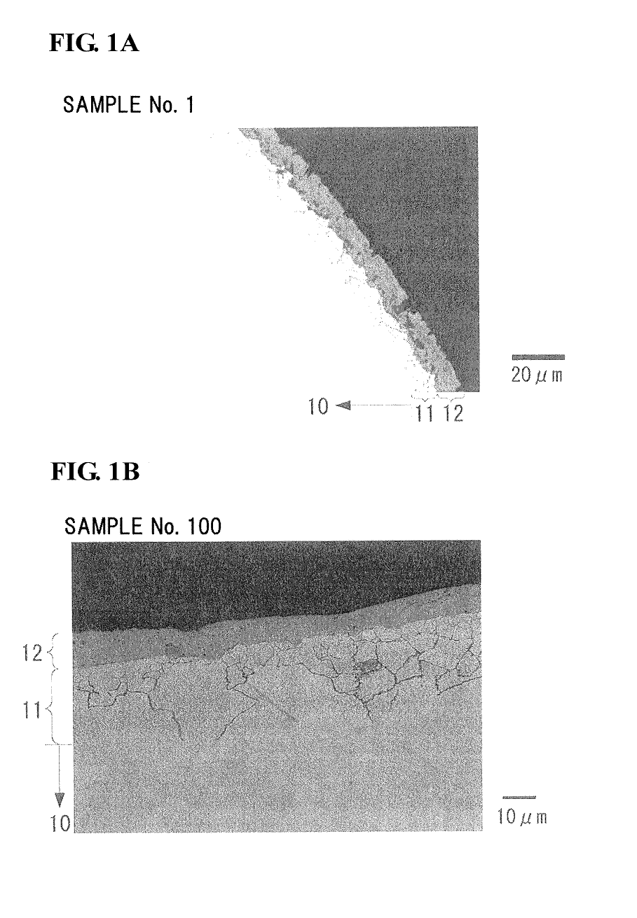

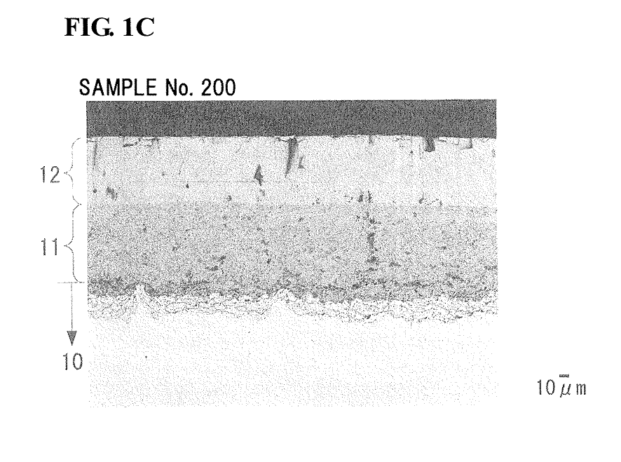

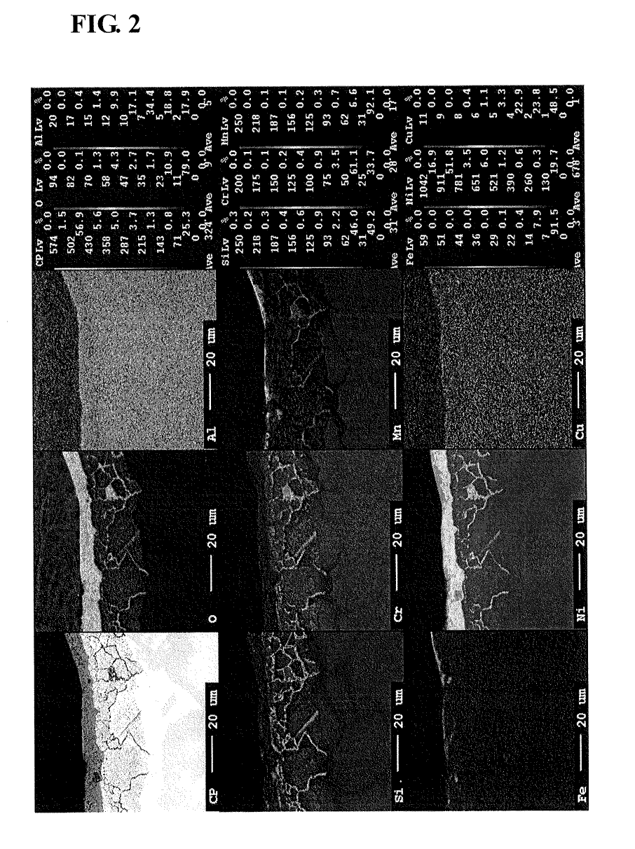

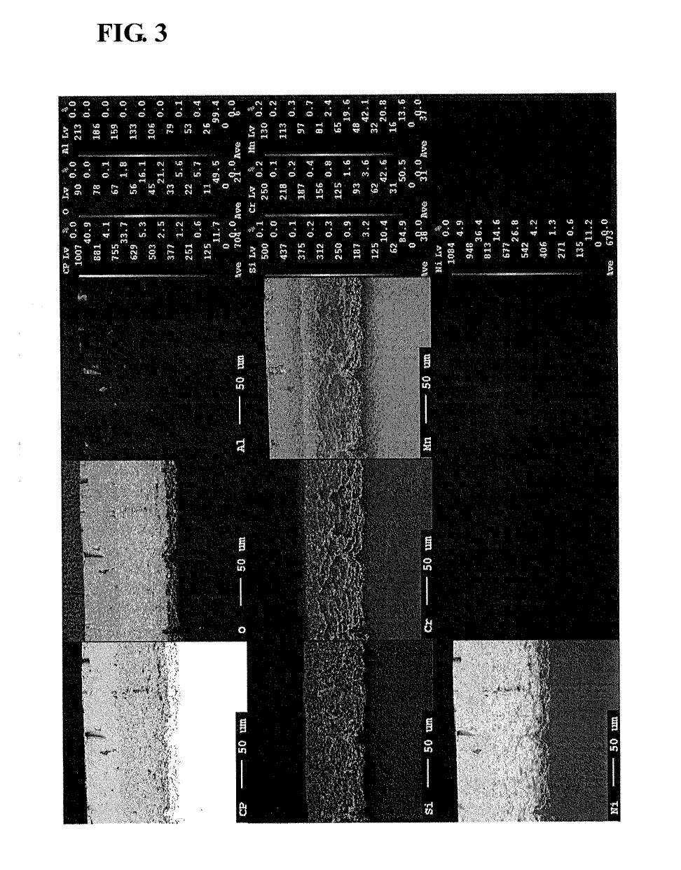

FIG. 1(B) shows a microstructure photograph of a cross section of Sample No. 100, FIG. 1(C) shows a microstructure photograph of a cross section of Sample No. 200, FIG. 2 shows mapping of element analysis of Sample No. 100, and FIG. 3 shows mapping of element analysis of Sample No. 200.

As shown in FIG. 1(B), in Sample No. 100 which has been actually used for the automobile, a double structure oxide film is formed on the surface of a base material 10 constituting the electrode, and streaky grain boundaries can be identified in an inside oxide layer 11 on the base material 10 side as compared with an outside oxide layer 12 on the surface side. As is clear from presence of these grain boundaries, the inside oxide layer 11 is formed from coarse grains (oxide grains). In this regard, as shown in FIG. 2, the outside oxide layer 12 is a layer which has a relatively high oxygen concentration and in which oxygen is uniformly present, while the inside oxide layer 11 is a layer which contains a relatively high concentration of Ni serving as a primary component of the base material 10 and which has a relatively low oxygen concentration. Therefore, it can be said that the states of oxides of the two layers 11 and 12 are different. In addition, it is clear that oxygen is present in a streaky manner in the inside oxide layer 11, i.e. oxygen is present at grain boundaries concentratedly. Consequently, it is considered that, in Sample No. 100 which has been actually used for the automobile, oxidation of the inside was not induced sufficiently because of presence of the outside oxide layer 12 on the surface side of the oxide film and, thereby, the inside oxide layer 11 was formed by oxide grains having a relatively low oxygen concentration. However, the oxide grains are coarse, so that grain boundaries are simple. Therefore, it can be said that further oxidation (corrosion) occurred along the grain boundaries in the inside oxide layer 11. It is considered that the oxidation along the grain boundaries occurred because of permeation of the corrosive solution. In this regard, the thickness of the oxide film of Sample No. 100 is about 20 μm.

On the other hand, as shown in FIG. 1(C), Sample No. 200 subjected to the simple oxidation test is similar to Sample No. 100, described above, which has been actually used for the automobile in the point that a double structure oxide film is formed on the surface of the base material 10 constituting the rectangular wire rod. However, as is clear from FIG. 3, in Sample No. 200, a difference between the oxygen concentration of the inside oxide layer 11 and the oxygen concentration of the outside oxide layer 12 is small, and the inside oxide layer 11 and the outside oxide layer 12 are formed from relatively uniform oxide grains. In this regard, considering the test time (72 hours), the thickness of the oxide film of Sample No. 200 is a very large 150 μm.

As described above, Sample No. 100 which has been actually used for the automobile and which was evaluated in the actual environment and Sample No. 200 after the simple oxidation test are different in the microstructure of the cross section and the results on the basis of SEM-EPMA element analysis and, therefore, it is clear that the corrosion behaviors are different between the simple oxidation test and the actual environment.

Meanwhile, as for Sample No. 1, initially, the above-described rectangular wire rod was heated under the condition of 900° C.×2 hours in the air atmosphere. In this regard, a NaCl aqueous solution containing nitric acid and phosphoric acid was prepared as the corrosive solution. Here, nitric acid, phosphoric acid, and a NaCl aqueous solution were prepared and mixed in such a way as to satisfy nitric acid:phosphoric acid:5 percent by mass sodium chloride aqueous solution=1:1:98 on a mass ratio basis. The resulting corrosive solution was heated to 60° C., the heated sample was immersed in this state, and holding was performed for a predetermined time selected from the range of 3 hours to 15 hours. After immersion was performed for the predetermined time, the sample was washed with water, and a CP cross section was taken. The microstructure of the resulting cross section was subjected to SEM observation. FIG. 1(A) shows a microstructure photograph of the cross section of Sample No. 1.

As is clear from FIG. 1(A), in Sample No. 1 subjected to the test including the steps of oxidation at a high temperature and, thereafter, immersion in the corrosive solution (hereafter this test is referred to as oxidation·immersion test), a double structure oxide film of the inside oxide layer 11 and the outside oxide layer 12 is formed on the surface of the base material 10 constituting the rectangular wire rod, streaky grain boundaries can be identified in the inside oxide layer 11, and the inside oxide layer 11 is formed from coarse grains. In addition, in Sample No. 1, the thickness of the oxide film is about 20 μm. From these points, it can be said that Sample No. 1 is provided with an oxide film similar to that of Sample No. 100 which has been actually used for the automobile. Also, from this point, it can be said that this oxidation·immersion test simulates the actual environment of the internal combustion engine accurately. Furthermore, the test time of Sample No. 1 is 17 hours at most and, therefore, it can be said that this oxidation·immersion test can reduce the test time considerably.

Consequently, it was verified that the method for evaluation testing of a material for an internal combustion engine, according to the present invention, including the steps of oxidation at a high temperature and, thereafter, immersion in the corrosive solution had the validity as a method for evaluating the characteristics (in particular, corrosion resistance) of the constituent member of the internal combustion engine. Also, it was verified that the method for evaluation testing of a material for an internal combustion engine, according to the present invention, was able to evaluate the characteristics (in particular, corrosion resistance) of the constituent member of the internal combustion engine conveniently.

Meanwhile, a sample heated under the condition of 900° C. to 1,000° C.×48 hours in a low-oxidizing atmosphere specified to have an oxygen content of 5 percent by volume ((I) a mixture gas of argon and oxygen, (II) a mixture gas of argon and the air) was prepared and the microstructure of the cross section after immersion into the same corrosive solution for the same time was subjected to SEM observation. As a result, in either case where the mixed gas of (I) or (II) was used, as with Sample No. 1, streaky grain boundaries were able to be identified in the inside oxide layer, and it was verified that a double structure oxide film including the inside oxide layer formed from coarse oxide grains was provided. Therefore, it was verified that the oxidation immersion test of this form was able to evaluate the characteristics (in particular, corrosion resistance) of the constituent member of the internal combustion engine accurately and conveniently.

Meanwhile, in place of the rectangular wire rod used in Test example 1, a rectangular wire rod (Ni content: about 80 percent by mass) made from INCONEL (registered trademark): Sample No. 10 and a rectangular wire rod made from another nickel alloy containing 0.35% γ-0.25% Si, on a percent by mass basis, and the remainder composed of Ni and inevitable impurities: Sample No. 20 were prepared, the oxidation·immersion test was performed under the same condition as that of Sample No. 1 in Test example 1 and, thereby, the corrosion state was examined. As a result of comparison between Sample No. 1, No. 10, and No. 20, which had different Ni contents, it was verified that, as the Ni purity (Ni content) increased, there was a tendency of corrosion to proceed easily (here, Sample No. 20 was corroded easily). Consequently, it was verified that the method for evaluation testing of a material for an internal combustion engine, according to the present invention, including the steps of oxidation at a high temperature and, thereafter, immersion in the corrosive solution was able to be utilized for selection of constituent members, which had excellent corrosion resistance, of the internal combustion engine.

In this regard, the present invention is not limited to the above-described embodiments and can be modified appropriately within the bounds of not departing from the gist of the present invention. For example, the material·shape and the like of the sample, the composition of the corrosive solution, the temperature, and the immersion time can be changed appropriately.

### INDUSTRIAL APPLICABILITY

The method for evaluation testing of a material for an internal combustion engine, according to the present invention, can be utilized favorably for evaluating the corrosion resistance of a metal material constituting parts incorporated in various internal combustion engines, e.g., gasoline engines and gas engines, of automobiles (typically, four-wheeled vehicles and two-wheeled vehicles). Also, the method for evaluation testing of a material for an internal combustion engine, according to the present invention, can be utilized for screening metal materials having excellent corrosion resistance.

1. A method for evaluation testing of a material for an internal combustion engine to evaluate the characteristics of a metal material of an electrode incorporated in the internal combustion engine, a raw material therefor, or the like, the method comprising the steps of:
forming an oxide film on the surface of a sample made from the metal material by holding the sample at a temperature of 800° C. or higher and 1,100° C. or lower in an oxygen-containing atmosphere; and
preparing an aqueous solution containing an acid and sodium chloride as a corrosive solution and immersing the sample provided with the oxide film in the corrosive solution for a predetermined time.

2. The method for evaluation testing of a material for an internal combustion engine, according to claim 1, wherein the oxide film is formed by holding for 1 hour or more and 100 hours or less in the air atmosphere, or holding for 2 hours or more and 200 hours or less in a low-oxidizing atmosphere in which the oxygen concentration is lower than that in the air.

3. The method for evaluation testing of a material for an internal combustion engine, according to claim 1, wherein the acid is at least one type of hydrochloric acid, phosphoric acid, nitric acid, and sulfuric acid.

4. The method for evaluation testing of a material for an internal combustion engine, according to claim 1, further comprising the steps of:
forming the oxide film by holding at a temperature of 900° C. for 24 hours in the air atmosphere; and
examining the state of the resulting oxide film.
